(19) United States
(12) Patent Application Publication
(10) Pub. No.: US 2023/0077287 A1
(43) Pub. Date: Mar. 9, 2023

(54) Systems for Cooling Recycled Off-Gas in Low-Density Polyethylene Production

(71) Applicant: ExxonMobil Chemical Patents Inc., Baytown, TX (US)

(72) Inventor: Cindy DEWITTE, Puurs-Sint-Amands (BE)

(21) Appl. No.: 17/759,452

(22) PCT Filed: Jan. 27, 2021
(86) PCT No.: PCT/US2021/015164

§ 371 Date: Jul. 26, 2022

Related U.S. Application Data
(60) Provisional application No. 62/979,695, filed on Feb. 21, 2020.

(51) Int. Cl. F28G 3/16; F28D 7/16; C08F 2/01

(52) U.S. Cl. CPC F28G 3/163; F28D 7/1607; C08F 2/01; F28D 2021/0022

(57) ABSTRACT

Improved heat exchanger systems and processes for cooling recycled off-gas in high pressure low-density polyethylene production. A system for exchanging heat between a first material and a second material can include a shell for containing the first material therein, a plurality of tubes disposed within the shell for containing the second material therein, a tube sheet disposed at an end of the shell for restricting flow of the second material to the shell, and at least one collector conduit disposed exterior to the shell for receiving at least one end of the plurality of tubes, wherein at least one of the plurality of tubes extend through the tube sheet to the collector conduit. A cleaning tool can be disposed within the collector conduit for cleaning the tubes. A process for cooling a gas stream can include introducing the gas stream to the heat exchanger system provided herein.

### CROSS-REFERENCE TO RELATED APPLICATION

This application claims the benefit of U.S. Provisional Application No. 62/979,695, filed Feb. 21, 2020, entitled “Systems for Cooling Recycled Off-Gas in Low-Density Polyethylene Production”, the entirety of which is incorporated by reference herein.

### FIELD

Embodiments of the present invention generally relate to heat exchanger cooling systems. More particularly, such embodiments relate to improved heat exchanger systems for cooling off-gas recycled to a high pressure low-density polyethylene reactor.

### BACKGROUND

In low-density polyethylene (LDPE) production, a high pressure recycle system cools the unreacted off-gas (containing ethylene) from a high pressure separator that is in fluid communication with the outlet of a high pressure LDPE reactor. The cooled gas is then fed to a secondary compressor and recycled to the LDPE reactor. This cooling operation has traditionally been performed using one or more double pipe heat exchangers in which unreacted off-gas flows through one pipe and cooling water flows through another pipe that surrounds the first pipe or vice versa. Heat is transferred from the off-gas to the cooling water, thereby cooling the off-gas.

One challenge of using double pipe heat exchangers in the recycle system is that such heat exchangers experience a high pressure drop. As a result, the secondary compressor needs to consume more power to increase the pressure of the unreacted off-gas being recycled to the LDPE reactor. Another drawback of using double pipe heat exchangers is that each heat exchanger is quite large and requires more space than desired within the manufacturing facility.

One alternative design of the high pressure recycle system has been the replacement of double pipe heat exchangers with shell and tube heat exchangers. Shell and tube heat exchangers include a shell, i.e., a large pressure vessel, with a bundle of tubes inside. Unreacted off-gas flows through the tubes and cooling water flows through the shell. Shell and tube heat exchangers advantageously experience less pressure drop and take up less space than double pipe heat exchangers because the tube bundle allows for a higher number of passes between the cooling water and the off-gas.

Despite these advantages of shell and tube heat exchangers, such heat exchangers have their own limitations. Since the tubes are contained within the shell of the heat exchanger and end at the tube sheet, the tubes are supported by being welded to the tube sheet. These welding points are potential leak sources and can result in gas leakage from the tubes to the shell. Thus, unreacted gas containing ethylene can undesirably accumulate in the shell of the heat exchanger, resulting in some of the ethylene not being recycled. Therefore, the cost of LDPE production can increase due to the gas leakage. It also creates a safety risk in the cooling system.

Yet another problem associated with the use of conventional shell and tube heat exchangers is that the tubes can become plugged by any wax that is entrained in the unreacted gas. This wax can form when low molecular weight polyethylene is no longer soluble in the unreacted gas solution due to a decrease in temperature. Fouled or plugged tubes can be difficult to clean since the tubes are located inside the shell of the heat exchanger. In addition, the tubes of conventional shell and tube heat exchangers are typically made of material that can undergo corrosion such as carbon steel and thus can begin to leak due to corrosion failure.

A need therefore exists for heat exchangers that are less likely to experience leakage and corrosion failure and thus have a longer lifetime. Heat exchangers that can be more easily cleaned are also highly desired.

### SUMMARY

Improved heat exchanger systems and processes that can be used to cool recycled off-gas in high pressure LDPE production are provided. In one or more embodiments, a system for exchanging heat between a first material and a second material can include a shell for containing the first material therein, a plurality of tubes disposed within the shell for containing the second material therein, a tube sheet disposed at an end of the shell for restricting flow of the second material to the shell, and at least one collector conduit disposed exterior to the shell for receiving at least one end of the plurality of tubes, wherein at least one of the plurality of tubes extend through the tube sheet to the collector conduit. A cleaning tool can be disposed within the collector conduit that includes a nozzle for spraying one of tubes with a fluid at a pressure up to 80 MPa during cleaning.

In one or more embodiments, processes for cooling a gas stream can include introducing a gas stream to one or more heat exchangers for cooling the gas stream, the one or more heat exchangers including a shell for containing a cooling medium therein, a plurality of tubes disposed within the shell for containing the gas stream therein, a tube sheet disposed at an end of the shell for restricting flow of the gas stream to the shell, and at least one collector conduit disposed exterior to the shell for receiving at least one of the ends of the plurality of tubes, wherein at least one of the plurality of tubes extend through the tube sheet to the collector conduit.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a flow diagram of an illustrative high pressure low-density polyethylene (LDPE) production process, according to one or more embodiments described herein.

FIG. 2 depicts a flow diagram of an illustrative high pressure recycle system that can be used in the LDPE production process of FIG. 1.

FIG. 3A depicts a partial side plan view of an illustrative shell and tube heat exchanger that can be used in the high pressure recycle system of FIG. 2, according to one or more embodiments described herein.

FIG. 3B depicts a detailed view of a portion of the heat exchanger from FIG. 3A, according to one or more embodiments described herein.

FIG. 4A depicts a side plan view of the shell of the heat exchanger from FIG. 3A with baffles arranged inside the shell, according to one or more embodiments described herein

FIG. 4B depicts a cross-sectional view of the shell and baffles from FIG. 4A, according to one or more embodiments described herein.

FIG. 5 depicts a side view of an illustrative cleaning tool that can be used to clean the tubes of the heat exchanger depicted in FIG. 3A, according to one or more embodiments described herein.

FIG. 5B depicts a cross-sectional view of the cleaning tool of FIG. 5, according to one or more embodiments described herein.

FIG. 6 depicts a cross-sectional view of an illustrative collector conduit that can receive the ends of the tubes of the heat exchanger from FIG. 3A and that can contain the cleaning tool from FIG. 5, according to one or more embodiments described herein.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

The term “α-olefin” refers to any linear or branched compound of carbon and hydrogen having at least one double bond between the α and β carbon atoms. For purposes of this specification and the claims appended thereto, when a polymer or copolymer is referred to as including an α-olefin, e.g., poly-α-olefin, the α-olefin present in such polymer or copolymer is the polymerized form of the α-olefin.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “in fluid communication” signifies that fluid can pass from a first component to a second component, either directly or via at least a third component. The term “inlet” refers to the point at which fluid enters a component, and the term “outlet” signifies the point at which fluid exits a component.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

An improved shell and tube heat exchanger system is disclosed that can include one or more heat exchangers containing a plurality of tubes disposed within a shell or vessel. The shell and tube heat exchanger system can serve as a cooling recycle system in, for example, a high pressure low-density polyethylene (LDPE) production process. Unreacted gas from a LDPE reactor can flow through the tubes, and a cooling fluid can flow through the shell such that heat is exchanged between the unreacted gas and the cooling fluid. A tube sheet can be disposed at the ends of the shell for restricting flow of the unreacted gas from the tubes to the shell. One or more collection conduits can be positioned exterior to the shell of each heat exchanger for receiving ends of the tubes. At least a portion of the tubes uniquely extend through the tube sheet in the shell to a collection conduit outside the shell. Therefore, there is no need to support the tubes running through the shell by connection to the shell. Due to the absence of potential leak sources at connection points, gas is less likely to accumulate in the shell.

The inventive heat exchanger system also advantageously can include tubes consisting essentially of duplex stainless steel, which is substantially resistant to corrosion, resulting in even less gas leakage from the tubes to the shell. The heat exchanger system can further include a pair of longitudinal baffles disposed within the shell on opposite sides of the shell. Such baffles can be positioned near an inlet of the shell, near an outlet of the shell and/or at multiple locations along a length of the shell. They can direct the flow of the cooling fluid more toward the middle of the shell and closer to the tubes, providing for better heat transfer.

The heat exchanger system can also include a cleaning tool positioned inside each collection conduit for removing wax and any other contaminants that build up inside of the tubes. The cleaning tool can include a nozzle for spraying the wax, etc. with a fluid such as water at a pressure sufficient to flush the wax to, for example, a blow down drum. Since the tubes extend outside the shell to the collection conduit, they are more easily accessible to a worker in a LDPE production plant. Therefore, the worker can easily determine when a tube leaving the shell is plugged by feeling whether the tube is colder than usual. The cleaning tool can then be rotated to a position in which the nozzle is aligned with the end of the plugged tube to permit fluid to flow through the nozzle. After the cleaning process is completed, the cleaning tool can be rotated back to a position in which fluid is no longer allowed to flow through the nozzle.

### LDPE Production Process

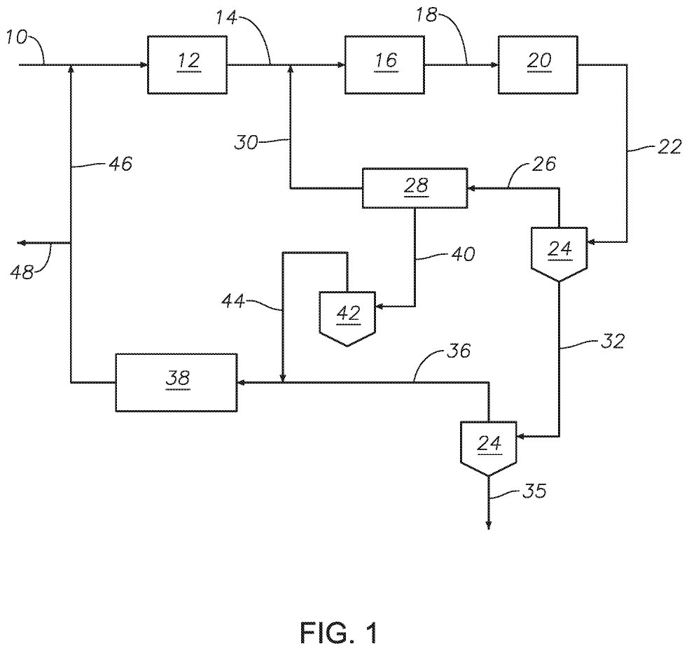

Turning to FIG. 1, a flow diagram of an exemplary high pressure LDPE production process is depicted that can employ the heat exchanger system provided herein. As shown, a feed stream 10 is first introduced to a primary compressor 12 to raise the pressure of the feed stream 10. The feed stream 10 can include raw material typically employed in a polymerization process to produce LDPE. For example, the feed stream 10 can include ethylene or ethylene mixed with at least one other comonomer if it is desirable to produce polyethylene copolymers. Alternatively, the feed stream 10 could include ethylene, and at least one other comonomer could be introduced to a compressed feed stream 14 leaving primary compressor 12.

Examples of suitable comonomers include: vinyl ethers such as vinyl methyl ether and vinyl ether; α-olefins such as propylene, 1-butene, 1-octene, and styrene; vinyl esters such as vinyl acetate, vinyl butyrate, and vinyl pivalate: haloolefins such as vinyl fluoride and vinylidene fluoride; acrylic esters such as methyl acrylate, ethyl acrylate, and methacrylates; other acrylic or methacrylic compounds such as acrylic acid, methacrylic acid, maleic acid, acrylonitrile, and acrylamide; and other compounds such as allyl alcohol, vinyl silanes, and other copolymerizable vinyl compounds. Two or more comonomers can be used, if desired. The α-olefin comonomer can be linear (e.g., linear C₃-C₂₀ α-olefins) or branched (e.g., α-olefins having one or more C₁-C₃ alkyl branches or an aryl group). Specific examples of α-olefins include C₃-C₁₂ α-olefins such as propylene; 1-butene; 3-methyl-1-butene; 3,3-dimethyl-1-butene; 1-pentene; 1-pentene with one or more methyl, ethyl, or propyl substituents; 1-hexene with one or more methyl, ethyl, or propyl substituents; 1-heptene with one or more methyl, ethyl, or propyl substituents; 1-octene with one or more methyl, ethyl or propyl substituents; 1-nonene with one or more methyl, ethyl or propyl substituents; ethyl, methyl, or dimethyl-substituted 1-decene; 1-dodecene; and styrene.

A compressed feed stream 14 that exits primary compressor 12 can be introduced to a secondary compressor 16 to further increase its pressure. A highly compressed feed stream 18 that exits secondary compressor 16 can then be introduced to a reactor 20 such as a tubular reactor or an autoclave reactor. The LDPE polymer or copolymer can be produced within reactor 20 using a high pressure and high temperature polymerization process. Various process variations that achieve safe and economical operating conditions are known in the art. By way of example, the polymerization process can be performed at a pressure of about 131 MPa to about 210 MPa and a temperature of about 148° C. to about 270° C. when a single autoclave reactor is used. It is to be understood that multiple reactors could be used instead.

The polymerization reaction can be enhanced by the injection of at least one modifier or chain transfer agent. The modifier can be injected upstream of the primary compressor, but it can alternatively be injected upstream of the secondary compressor or upstream of the reactor. Examples of suitable modifiers include isobutylene, propylene, n-butane, hexane, propane, 1-butene, and aldehydes such as acetaldehyde and propionaldehyde.

An effluent stream 22 containing LDPE polymer or copolymer and unreacted ethylene, comonomer, and/or modifier exits reactor 20. This effluent stream 22 can be introduced to a high pressure separator 24 after undergoing a pressure drop in a valve. The high pressure separator 24 can split the effluent stream 22 into a polymer rich liquid phase 32 and an unreacted gas phase 26. The polymer rich liquid phase 32 that exits the bottom of the high pressure separator 24 can be directed to a low pressure separator 34 in which the pressure is further reduced. A polymer-containing liquid stream 35 that exits the bottom of low pressure separator 34 can be sent to an extruder to pelletize the polymer if desired. An unreacted gas stream 36 that exits the low pressure separator 34 can be directed to a recycle purge compressor 38 to increase the pressure of stream 36 to that of feed stream 10. A recycled gas stream 46 that exits the purge compressor 38 can then be introduced to feed stream 10. A portion of the gas stream 46 exiting the purge compressor 38 can also be sent to purification via stream 48.

The unreacted gas stream 26 that exits high pressure separator 24 can be introduced to a cooling recycle system 28, which can include the shell and tube heat exchanger system disclosed herein. The unreacted gas stream 26 can enter the cooling recycle system 28 at a temperature of, e.g., about 100° C. to about 300° C., preferably about 150° C. to about 280° C., and more preferably about 200° C. to about 260° C. A cooled unreacted gas stream 30 exits the recycle system 28 at a temperature of, e.g., about 15° C. to about 80° C., preferably about 15° C. to about 50° C., and more preferably about 15° C. to about 30° C. The pressure drop across the entire cooling recycle system 28 can be as low as about 0.5 MPa to about 1.5 MPa, which is a significant improvement over a conventional recycle system using double pipe heat exchangers.

The cooled unreacted gas stream 30 can be recycled back to the compressed feed stream 14 to allow unreacted ethylene, comonomer, and/or modifier to be reintroduced to the secondary compressor 16, which is in fluid communication with the LDPE reactor 20. Wax entrained in the unreacted gas passing through cooling recycle system 28 can flow down to a blowdown drum 42 via stream 40. Any gas that accumulates in the blowdown drum 42 can be directed to gas stream 36 via stream 44 for recycling.

### Heat Exchanger System

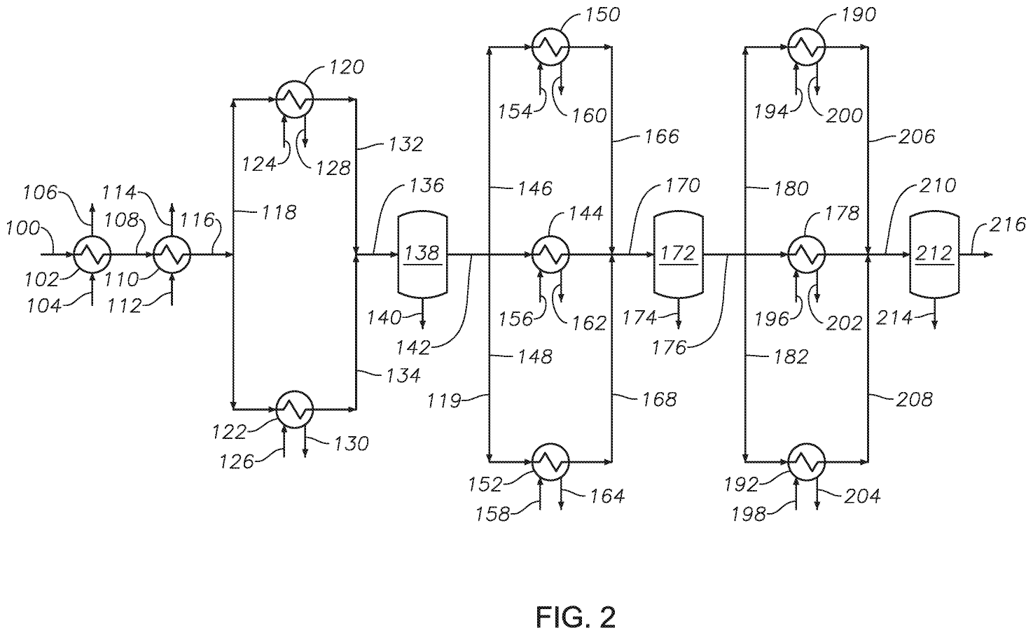

The heat exchanger system disclosed herein can serve as the cooling recycle system 28 of FIG. 1. A flow diagram of an illustrative heat exchanger system is shown in FIG. 2. A gas stream 100 (such as unreacted gas stream 26 from FIG. 1) can first be fed to one or more waste heat boilers 102 and 110 arranged in series to recuperate waste heat from the gas stream 100 and produce steam that can be used in other processes. Water 104 that is passed to waste heat boiler 102 can be converted to medium pressure steam 106 having a pressure of about 1 MPag to about 2 MPag. An outlet stream 108 that exits waste heat boiler 102 can be introduced to the inlet of waste heat boiler 110. Water 112 that is passed to boiler 110 can be converted to low pressure steam 114 having a pressure of about 0.3 to about 0.5 MPag.

An outlet stream 116 that exits waste heat boiler 110 can be passed to sets of parallel shell and tube heat exchangers arranged in series. The first set can employ hot water as the cooling medium, the second set can employ cooling tower water as the cooling medium, and the third set can employ chilled water as the cooling medium. Gradual cooling of the unreacted gas in this manner results in more energy efficient operation of the cooling recycle system. One embodiment of these sets of parallel shell and tube heat exchangers is shown in FIG. 2. More specifically, the outlet stream 116 from waste heat boiler 110 can be split into a first stream 118 being introduced to a shell and tube heat exchanger 120 and a second stream 119 being introduced to a shell and tube heat exchanger 122. Hot water as cold as practicable (e.g., when economics, etc. are considered), typically between about 40° C. and about 60° C., can be passed into heat exchangers 120 and 122 via streams 124 and 126, respectively, and can exit heat exchangers 120 and 122 via streams 128 and 130, respectively. The outlet stream 132 that exits heat exchanger 120 and the outlet stream 134 that exits heat exchanger 122 can be combined into gas stream 136, which can then be fed to a vapor-liquid separator 138 (also called a knock-out drum). The vapor-liquid separator 138 can remove liquids such as waxes entrained in the gas stream 136, and such liquids can be removed from the bottom of vapor-liquid separator via stream 140.

An outlet stream 142 that exits vapor-liquid separator 138 can then be separated into two additional streams 146 and 148 before being fed to a shell and tube heat exchanger 144. Stream 146 can be introduced to a shell and tube heat exchanger 150, and stream 148 can be introduced to a shell and tube heat exchanger 152. Cooling tower water as cold as practicable depending on current weather conditions can be passed into heat exchangers 150, 144, and 152 via streams 154, 156, and 158, respectively, and can exit heat exchangers 150, 144, and 152 via streams 160, 162, and 164, respectively. For example, the cooling tower water temperature can vary depending on the climate of the country where the LDPE production process is located and on whether on what season it is (hotter in the summer and colder in the winter). By way of example, the cooling tower water could be between about 10° C. and about 40° C. An outlet stream 166 that exits heat exchanger 150 and an outlet stream 168 that exits heat exchanger 152 can be introduced to gas stream 170 that exits heat exchanger 144. This gas stream 170 can then be fed to a vapor-liquid separator 172. The vapor-liquid separator 172 can remove liquids such as waxes entrained in the gas stream 170 via stream 174.

An outlet stream 176 from vapor-liquid separator 172 can thereafter be divided into two additional streams 180 and 182 before being introduced to a shell and tube heat exchanger 178. Stream 180 can be introduced to a shell and tube heat exchanger 190, and stream 182 can be introduced to a shell and tube heat exchanger 192. Chilled water as cold as practicable, typically between about 5° C. and about 10° C. can be passed into heat exchangers 190, 178, and 192 via streams 194, 196, and 198, respectively, and can exit heat exchangers 190, 178, and 192 via streams 200, 202, and 204, respectively. An outlet stream 206 that exits heat exchanger 190 and an outlet stream 208 that exits heat exchanger 192 can be introduced to a gas stream 210 that exits heat exchanger 178, which can then be fed to a vapor-liquid separator 212. The vapor-liquid separator 212 can remove liquids such as waxes entrained in the gas stream 210 via stream 214. An outlet stream 216 that exits vapor-liquid separator can then be introduced to a compressor such as secondary compressor 16 from FIG. 1.

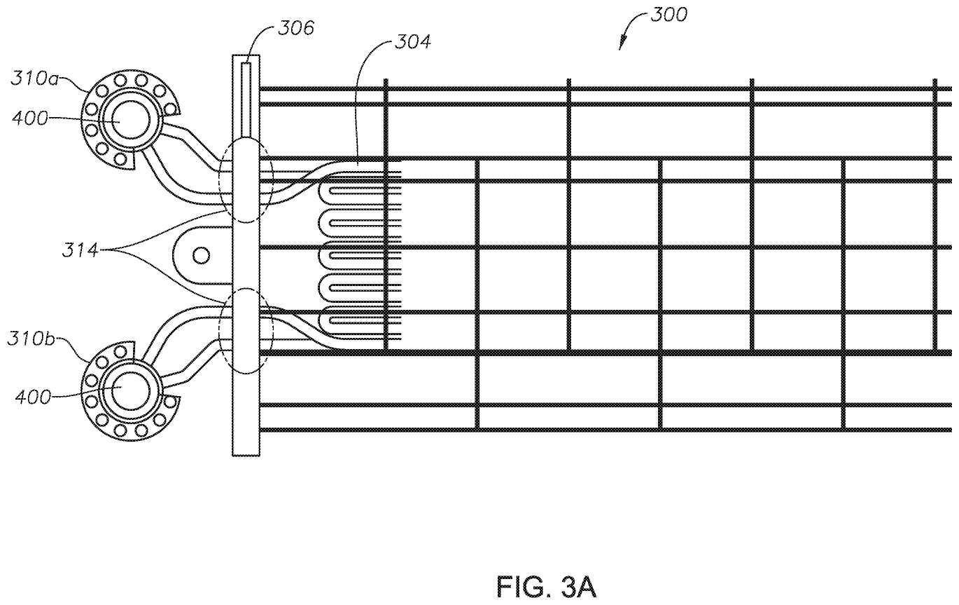

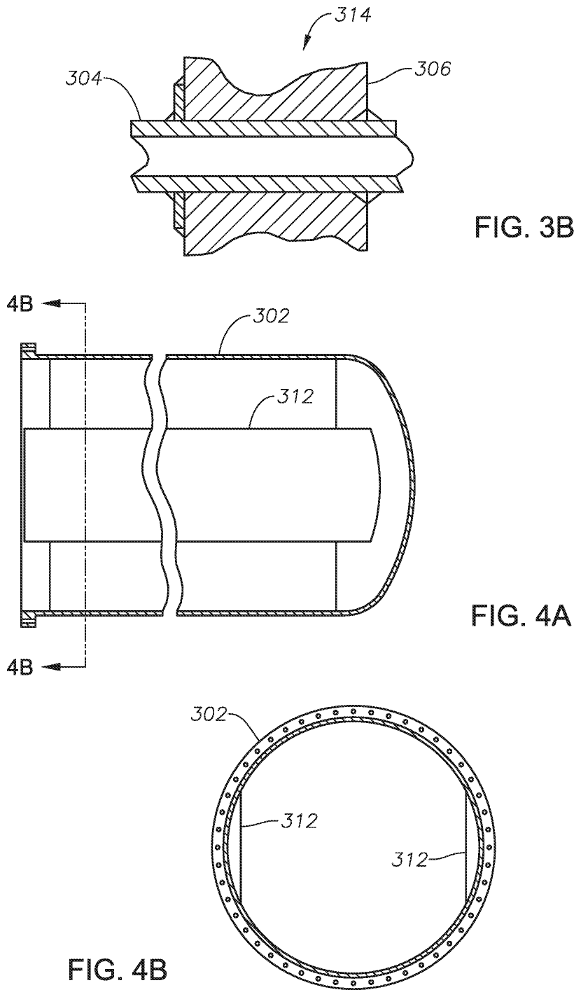

FIG. 3A depicts a side view of a portion of an improved heat exchanger 300 that can be employed as one or more of the heat exchangers shown in FIG. 2. Heat exchanger 300 can include a shell (shown later in FIG. 4A), i.e., a container or vessel, through which a first material can flow through the heat exchanger 300. As shown, a bundle of tubes 304 can extend through the center of the heat exchanger 300, and a second material can flow through these tubes 304. Heat can be exchanged between the first and second materials. In one embodiment, the first material flowing through shell 302 can be or can include water or other heat transfer fluid, and the second material flowing through tubes 304 can be or can include the unreacted gas from a polyolefin production process. It is to be understood that the first material and the second material could be reversed with respect to their flow through heat exchanger 300.

The tubes 304 can be made of any suitable material that is substantially resistant to corrosion and can withstand the desired operating conditions within the exchanger 300. A particularly suitable material is duplex stainless steel. Duplex stainless steel has a two-phase microstructure that includes both grains of ferritic stainless steel and grains of austenitic stainless steel. Another suitable material that tubes 304 can be composed of is austenitic stainless steel such as SAE 316L grade stainless steel. The tubes 304 also can include both duplex stainless steel and austenitic stainless steel.

Still referring to FIG. 3A, a tube sheet 306 can be disposed laterally at one end of shell 302 to restrict flow of the second material from the tubes 304 to the shell 302. The ends of tubes 304 can extend through the tube sheet 306 to input and output collection conduits 310a and 310b. The input collection conduit 310a can serve to deliver the second material to a first or “input” end of each tube 304, and the output collection conduit 310b can serve to receive the second material from a second or “output” end of each tube 304, or vice versa.

The tubes 304 can be configured with up to as many parallel flows and passes as one skilled in the art deems necessary. For example, the heat exchanger 300 can include up to twenty tubes 304 arranged in parallel with each tube making up to twelve passes to provide for relatively high cooling capacity. As used herein, each “pass” is equivalent to one “tube length”, i.e., the length of the tube between the tube sheet 306 and the opposite end of the shell 302 of the heat exchanger 300. Thus, each tube 304 can be arranged such that the material flowing through the tube 304 flows one tube length horizontally in a first direction (equivalent to one pass) and then flows one tube length horizontally in a second direction opposite to the first direction (equivalent to a second pass). This flow pattern can be repeated for up to twelve passes before the material within each tube 304 exits the heat exchanger 300. Since the heat exchanger 300 can include up to twenty tubes 304, the total number of tube lengths formed by the tubes 304 can be up to 240. It is to be understood that tubes 304 could be arranged in various other configurations, as is commonly known in the art.

FIG. 3B depicts an enlarged detailed view of a portion 314 of heat exchanger 300 to more clearly illustrate one of the tubes 304 extending through the tube sheet 306. Because the ends of tubes 304 extend through the tube sheet 306, there is no need to weld tubes 304 to the tube sheet 306. Consequently, gas is less likely to leak from the tubes 304 and undesirably accumulate in the shell 302.

FIG. 4A depicts a side plan view of the shell 302 of heat exchanger 300 from FIG. 3A and illustrates that heat exchanger 300 can also include one or more baffles 312 positioned longitudinally along the length of the shell 302. FIG. 4B is a cross-section of shell 302 through the lines 4B-4B shown in FIG. 4A. It shows that baffles 312 can be positioned adjacent to opposite sides of the shell 302. The baffles 312 can be arranged in this manner to direct flow in the shell 302 more toward the center and closer to the tubes 304. It is to be recognized that other configurations of the baffles 312 are possible, depending on where direction of the flow through shell 302 is to be directed.

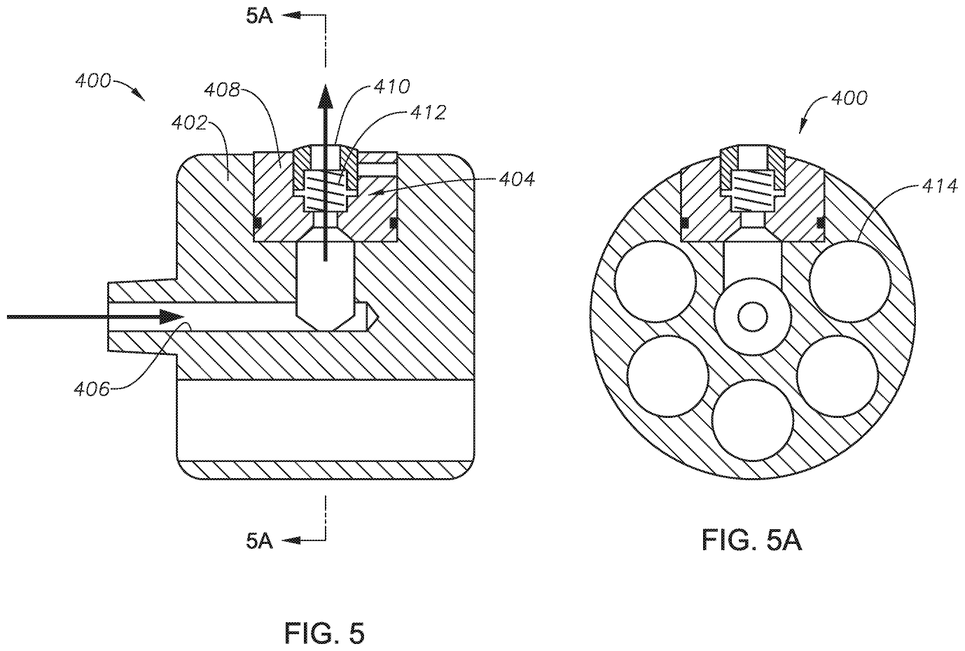

FIG. 5 depicts a side view of an illustrative cleaning tool 400 that can be used to clean the tubes of the heat exchanger 300 depicted in FIG. 3A, and FIG. 5A depicts a cross-section of the cleaning tool (viewed along the lines 5A-5A shown in FIG. 5). As shown in FIG. 5, a cleaning tool 400 can be used to remove contaminants such as wax from the tubes 304 of FIG. 3A. The cleaning tool 400 can include a housing 402 in which a nozzle 404 is located within. An opening or conduit 406 can be positioned within housing 402 for directing a fluid, such as water through the housing 402 to the nozzle 404. The bold arrows in FIG. 5 show the direction of fluid (e.g., water) flow into and through the tool 400. An alignment nose 408 can be positioned adjacent to the nozzle 404 for holding the nozzle 404 in place. The nozzle 404 can include a piston 410 and a spring 412 to regulate the flow of the fluid.

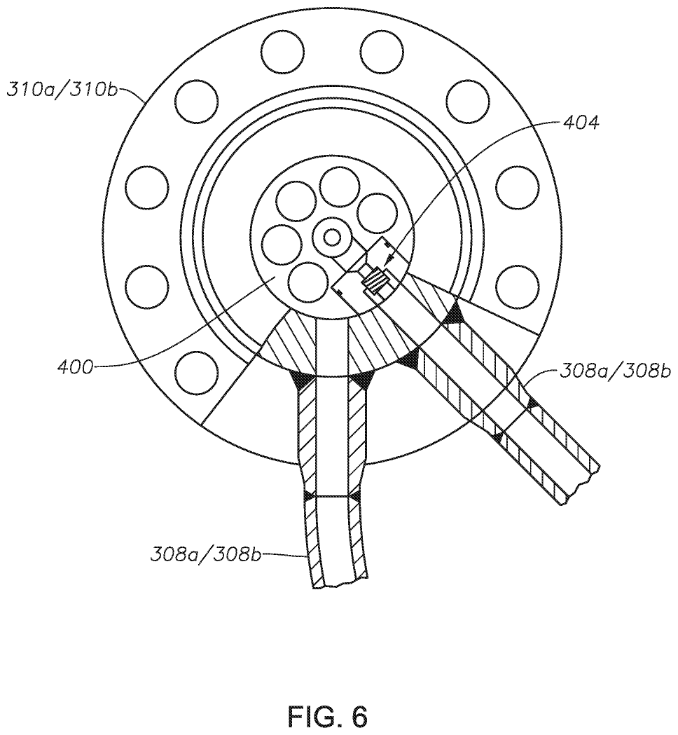

FIG. 5A, as noted, depicts a cross-section of the cleaning tool 400, and in particular shows one or more openings or holes 414 can be drilled through the cleaning tool 400 to lighten its weight. The lower the weight of the cleaning tool 400, the easier it is for an operator to manipulate moving the cleaning tool 400. As shown in FIG. 6, the cleaning tool 400 can be positioned within inlet and outlet collection conduits 310a and 310b.

A worker can easily determine when one of the tubes 304 is plugged by feeling the exterior of the tube ends 308a and 308b leading to the collection conduits 310a and 310b. When one of the tube ends 308a or 308b is colder than usual, this indicates that the corresponding tube 304 is plugged.

The cleaning tool 400 can then be operated by rotating the tool 400 to a position in which the piston 410 is aligned with the tube 304 that needs cleaning. When the tool 400 is in this position, fluid, e.g., water, can be sprayed from the nozzle 404 at a pressure of up to about 80 MPa. The force of the fluid washes the contaminant from where it has built up in the tube 304. To terminate the cleaning process, the cleaning tool 400 can be rotated back to its original position in which the nozzle is forced against the inner wall of the collection conduit 310a or 310b by the spring 412, thereby restricting flow of fluid from the nozzle 404.

The cleaning tool 400 can also be used to remove fouling from the tubes 304 in the same manner described above.

### Listing of Embodiments

This disclosure may further include any one or more of the following non-limiting embodiments:

1. A system for exchanging heat between a first material and a second material, comprising: a shell for containing the first material therein; a plurality of tubes disposed within the shell for containing the second material therein, a tube sheet disposed at an end of the shell for restricting flow of the second material to the shell; and at least one collector conduit disposed exterior to the shell for receiving at least one end of the plurality of tubes, wherein at least one of the plurality of tubes extend through the tube sheet to the collector conduit.

2. The heat exchanger system of embodiment 1, wherein the at least one collector conduit comprises an input collector conduit and an output collector conduit, wherein at least one input end of the tubes are in fluid communication with the input collector conduit for receiving the second material from the input collector conduit, and wherein at least one output end of the tubes are in fluid communication with the output collector conduit for delivering the second material to the output collector conduit.

3. The heat exchanger system of embodiment 1 or 2, wherein the plurality of tubes consists essentially of duplex stainless steel, austenitic stainless steel, or combinations thereof.

4. The heat exchanger system of embodiments 1 to 3, further comprising a pair of longitudinal baffles disposed within the shell adjacent to opposite sides of the shell.

5. The heat exchanger system of embodiment 4, wherein the pair of longitudinal baffles is disposed near an inlet of the shell, near an outlet of the shell, or at multiple locations along a length of the shell.

6. The heat exchanger system of embodiments 1 to 5, further comprising a cleaning tool disposed within the at least one collector conduit comprising a nozzle for spraying one of the ends of the plurality of tubes with a fluid during cleaning.

7. The heat exchanger system of embodiment 6, wherein the cleaning tool is capable of being rotated to a first position in which the nozzle is aligned with said one of the ends of the plurality of tubes and the fluid is permitted to flow from the nozzle.

8. The heat exchanger system of embodiment 6 or 7, wherein the cleaning tool is capable of being rotated to a second position in which the nozzle is not aligned with said one of the ends of the plurality of tubes and the fluid is not permitted to flow from the nozzle.

9. The heat exchanger system of embodiments 1 to 8, wherein the plurality of tubes comprises up to twenty tubes arranged in parallel, and wherein each tube is arranged to have up to twelve passes.

10. A process for cooling a gas stream comprising: introducing a gas stream to one or more heat exchangers for cooling the gas stream, the one or more heat exchangers comprising: a shell for containing a cooling medium therein; a plurality of tubes disposed within the shell for containing the gas stream therein, a tube sheet disposed at an end of the shell for restricting flow of the gas stream to the shell; and at least one collector conduit disposed exterior to the shell for receiving at least one of the ends of the plurality of tubes, wherein at least one of the plurality of tubes extend through the tube sheet to the collector conduit.

11. The process of embodiment 10, wherein the gas stream is directed from a separator in fluid communication with an outlet of a polyethylene producing reactor to the one or more heat exchangers to form a cooled gas stream, wherein the cooled gas stream is recycled to a compressor in fluid communication with an inlet of the polyethylene producing reactor.

12. The process of embodiment 10 or 11, wherein the gas stream is introduced to one or more boilers arranged in series for producing steam before being introduced to the one or more heat exchangers.

13. The process of embodiments 10 to 12, wherein the plurality of tubes consists essentially of duplex stainless steel, austenitic stainless steel, or combination thereof.

14. The process of embodiments 10 to 13, wherein the one or more heat exchangers further comprise a pair of longitudinal baffles disposed within the shell adjacent to opposite sides of the shell.

15. The process of embodiments 10 to 14, wherein the one or more heat exchangers further comprise a cleaning tool disposed within the at least one collector conduit, the cleaning tool comprising a nozzle for spraying one of the ends of the plurality of tubes with a fluid at a pressure up to about 80 MPa.

16. The process of embodiments 10 to 15, wherein the plurality of tubes comprises up to twenty tubes arranged in parallel, and wherein each tube is arranged to have up to twelve passes.

17. The process of embodiments 10 to 16, further comprising introducing the gas stream to a first set of the one or more heat exchangers arranged in parallel for cooling the gas stream with hot water at a temperature of about 40° C. to about 60° C.

18. The process of embodiment 17, further comprising introducing the gas stream exiting the first set of the one or more heat exchangers to a first vapor-liquid separator for removing liquid from the gas stream.

19. The process of embodiment 18, further comprising introducing the gas stream exiting the first vapor-liquid separator to a second set of the one or more heat exchangers arranged in parallel for cooling the gas stream with cooling tower water at a temperature of about 10° C. to about 40° C.

20. The process of embodiment 19, further comprising introducing the gas stream exiting the second set of the one or more heat exchangers to a second vapor-liquid separator.

21. The process of embodiment 20, further comprising introducing the gas stream exiting the second vapor-liquid separator to a third set of the one or more heat exchangers arranged in parallel for cooling the gas stream with chilled water at a temperature of about 5° C. to about 10° C.

22. The process of embodiment 21, further comprising introducing the gas stream exiting the third set of the one or more heat exchangers to a third vapor-liquid separator.

23. A process for cleaning the heat exchanger system of embodiment 6, comprising rotating the cleaning tool to a first position such that the nozzle is aligned with said at least one of the ends of the plurality of tubes to permit fluid to flow from the nozzle at a pressure up to about 80 MPa.

24. The process of embodiment 23 or 6, further comprising rotating the cleaning tool to a second position such that the nozzle is not aligned with said one of the ends of the plurality of tubes and the fluid is not permitted to flow from the nozzle, thereby terminating the cleaning process.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A system for exchanging heat between a first material and a second material, comprising:
a shell for containing the first material therein;
a plurality of tubes disposed within the shell for containing the second material therein,
a tube sheet disposed at an end of the shell for restricting flow of the second material to the shell; and
at least one collector conduit disposed exterior to the shell for receiving at least one end of the plurality of tubes, wherein at least one of the plurality of tubes extend through the tube sheet to the collector conduit.

2. The heat exchanger system of claim 1, wherein the at least one collector conduit comprises an input collector conduit and an output collector conduit, wherein at least one input end of the tubes are in fluid communication with the input collector conduit for receiving the second material from the input collector conduit, and wherein at least one output end of the tubes are in fluid communication with the output collector conduit for delivering the second material to the output collector conduit.

3. The heat exchanger system of claim 1, wherein the plurality of tubes consists essentially of duplex stainless steel, austenitic stainless steel, or combinations thereof.

4. The heat exchanger system of claim 1, further comprising a pair of longitudinal baffles disposed within the shell adjacent to opposite sides of the shell.

5. The heat exchanger system of claim 4, wherein the pair of longitudinal baffles is disposed near an inlet of the shell, near an outlet of the shell, or at multiple locations along a length of the shell.

6. The heat exchanger system of claim 1, further comprising a cleaning tool disposed within the at least one collector conduit comprising a nozzle for spraying one of the ends of the plurality of tubes with a fluid during cleaning.

7. The heat exchanger system of claim 6, wherein the cleaning tool is capable of being rotated to a first position in which the nozzle is aligned with said one of the ends of the plurality of tubes and the fluid is permitted to flow from the nozzle; and further wherein the cleaning tool is capable of being rotated to a second position in which the nozzle is not aligned with said one of the ends of the plurality of tubes and the fluid is not permitted to flow from the nozzle.

8. (canceled)

9. The heat exchanger system of claim 1, wherein the plurality of tubes comprises up to twenty tubes arranged in parallel, and wherein each tube is arranged to have up to twelve passes.

10. A process for cooling a gas stream comprising:
introducing a gas stream to one or more heat exchangers for cooling the gas stream, the one or more heat exchangers comprising:
a shell for containing a cooling medium therein;
a plurality of tubes disposed within the shell for containing the gas stream therein,
a tube sheet disposed at an end of the shell for restricting flow of the gas stream to the shell; and
at least one collector conduit disposed exterior to the shell for receiving at least one of the ends of the plurality of tubes, wherein at least one of the plurality of tubes extend through the tube sheet to the collector conduit.

11. The process of claim 10, wherein the gas stream is directed from a separator in fluid communication with an outlet of a polyethylene producing reactor to the one or more heat exchangers to form a cooled gas stream, wherein the cooled gas stream is recycled to a compressor in fluid communication with an inlet of the polyethylene producing reactor.

12. The process of claim 11, wherein the gas stream is introduced to one or more boilers arranged in series for producing steam before being introduced to the one or more heat exchangers.

13. The process of claim 10, wherein the plurality of tubes consists essentially of duplex stainless steel, austenitic stainless steel, or combinations thereof.

14. The process of claim 10, wherein the one or more heat exchangers further comprise a pair of longitudinal baffles disposed within the shell adjacent to opposite sides of the shell; and further wherein the one or more heat exchangers further comprise a cleaning tool disposed within the at least one collector conduit, the cleaning tool comprising a nozzle for spraying one of the ends of the plurality of tubes with a fluid at a pressure up to 80 MPa.

15. (canceled)

16. The process of claim 10, wherein the plurality of tubes comprises up to twenty tubes arranged in parallel, and wherein each tube is arranged to have up to twelve passes.

17. The process of claim 10, further comprising (a) introducing the gas stream to a first set of the one or more heat exchangers arranged in parallel for cooling the gas stream with hot water at a temperature of 40° C. to 60° C.; (b) introducing the gas stream, after it exits the first set of the one or more heat exchangers, to a first vapor-liquid separator for removing liquid from the gas stream; (b) introducing the gas stream, after it exits the first vapor-liquid separator, to a second set of the one or more heat exchangers arranged in parallel for cooling the gas stream with cooling tower water at a temperature of 10° C. to 40° C.; (c) introducing the gas stream, after it exits the second set of the one or more heat exchangers, to a second vapor-liquid separator; (d) introducing the gas stream, after it exits the second vapor-liquid separator, to a third set of the one or more heat exchangers arranged in parallel for cooling the gas stream with chilled water at a temperature of 5° C. to 10° C.; and (e) introducing the gas stream, after it exits the third set of the one or more heat exchangers, to a third vapor-liquid separator.

18.-22. (canceled)

23. A process for cleaning the heat exchanger system of claim 6, comprising rotating the cleaning tool to a first position such that the nozzle is aligned with said at least one of the ends of the plurality of tubes to permit fluid to flow from the nozzle at a pressure up to about 80 MPa.

24. The process of claim 23, further comprising rotating the cleaning tool to a second position such that the nozzle is not aligned with said one of the ends of the plurality of tubes and the fluid is not permitted to flow from the nozzle, thereby terminating the cleaning process.
